(19) United States
(12) Patent Application Publication
(10) Pub. No.: US 2026/0369729 A1
(43) Pub. Date: Nov. 19, 2026

(54) BATTERY SYSTEM AND MOTOR VEHICLE

(71) Applicant: AUDI AG, Ingolstadt (DE)

(72) Inventors: Uwe GERLINGER, Kipfenberg (DE); Carsten LORENZ, Reichertshofen (DE); Eduard MAIN, Buxheim (DE)

(73) Assignee: AUDI AG, Ingolstadt (DE)

(21) Appl. No.: 19/670,761

(22) Filed: May 7, 2026

(30) Foreign Application Priority Data
May 14, 2025 (DE) 102025118505.0

(51) Int. Cl. H01M 10/6555; H01M 10/613; H01M 10/617; H01M 10/625; H01M 10/653; H01M 10/6551; H01M 10/6569; H01M 50/209; H01M 50/211; H01M 50/249

(52) U.S. Cl. CPC H01M 10/6555; H01M 10/613; H01M 10/617; H01M 10/625; H01M 10/653; H01M 10/6551; H01M 10/6569; H01M 50/249; H01M 50/209; H01M 50/211

(57) ABSTRACT

A battery system for a motor vehicle including at least one battery cell and at least one temperature control element for temperature control of the at least one battery cell. The at least one temperature control element is in contact with a first main surface of the battery cell at least in some sections. The battery system includes at least one heat conductor arranged on a second main surface of the battery cell opposite the first main surface, the at least one heat conductor and the at least one temperature control element are thermally conductively connected to each other.

### FIELD

The present invention relates to a battery system for a motor vehicle comprising at least one battery cell and at least one temperature control element for temperature control of the at least one battery cell, wherein the at least one temperature control element is in contact with a first main surface of the battery cell at least in some regions. The invention furthermore relates to a motor vehicle.

### BACKGROUND

DE 10 2011 081 149 A1 discloses a heat sink with a graphite-containing flat material intended for contact with one or more battery cells. The heat sinks are arranged between battery cells and connected to a cooling module arranged at the front.

DE 20 2013 001 662 U1 discloses a composite heat distributor comprising a first and a second flexible graphite layer as well as a gas-generating layer arranged in between.

US 2018/0159189 A1 discloses a thermal management arrangement for a battery cell with opposing main surfaces, wherein the arrangement comprises a flexible graphite heat distributor that contacts at least one of the opposing main surfaces of the battery cell.

In other known designs, cooling is often achieved through so-called inter-cell cooling, wherein flat temperature control elements are arranged between adjacent battery cells. In prismatic cells with a small thickness, cooling on both sides of the two large main surfaces of the cells leads to a comparatively homogeneous temperature distribution inside the cell.

To reduce installation space and/or costs, as well as to increase energy density, one-sided cooling is increasingly used, in which the temperature control element is only arranged on every second cell. The other intermediate spaces are filled by mechanically supporting and/or insulating materials, such as so-called volume compensation elements and/or swelling pads.

However, this asymmetrical cooling arrangement leads to a significant temperature spread within the battery cell, especially in the “thickness direction” or between the two main surfaces of the battery cell. As a result, an inhomogeneous temperature distribution occurs in the cell active material, which can limit the usable operating range. Furthermore, the risk of accelerated aging of the electrochemical system and thermally unfavorable propagation in the event of a fault increases. In prismatic cells, the heat-conducting effect of the cell housing is often insufficient for compensating, while in pouch cells it is completely absent.

### SUMMARY

The object of the present invention is to eliminate the disadvantages known from the prior art. The object is, in particular, to provide a battery system that ensures the most homogeneous temperature distribution possible within the battery cells, also with one-sided cooling, in order to improve operational stability, performance and lifespan of the cells. The aim is to reduce temperature spread in the direction of cell thickness, in particular, without significantly increasing the installation space or introducing additional complex cooling systems.

A battery system for a motor vehicle is proposed. The battery system is preferably a motor vehicle battery system. The battery system comprises at least one battery cell and at least one temperature control element. The temperature control element is preferably designed as an active temperature control element. Preferably, the temperature control element is designed as a fluid-traversed temperature control element.

The temperature control element is used for temperature control, in particular heating and/or cooling, of the at least one battery cell. The temperature control element can therefore ensure heat dissipation during the charging process and heat input during heating operation. This ensures that the temperature of the battery cell is always kept within the optimal range. The at least one temperature control element is in contact with a first main surface of the battery cell, at least in sections. The contact of the temperature control element with the first main surface of the battery cell ensures the greatest possible and/or most direct heat transfer.

According to the invention, the battery system comprises at least one heat conductor arranged on a second main surface of the battery cell, in particular in contact therewith, at least in sections. The second main surface is opposite the first main surface. The at least one heat conductor and the at least one temperature control element are thermally connected to each other. The heat conductor thus provides the second main surface as a heat transfer path in addition to the first main surface. This reduces the temperature spread along a cell thickness and improves the homogeneity of the cell temperature. This allows for an effect that is almost comparable to that achieved with cell architectures cooled on both sides. Compared to a second temperature control element, the heat conductor saves installation space because it has a smaller thickness. In comparison to other heat conductors used exclusively, as known from the prior art, the cooling effect of the present invention is increased due to the shortened heat transfer paths of the heat conductors to the temperature control element and/or due to the one-sided active cooling by the temperature control element.

It is advantageous if the first main surface and the second main surface are the two larger or largest surfaces of the battery cell. The use of large areas optimizes thermal coupling with minimal space requirements. The first main surface and the second main surface are opposite each other. The arrangement of opposing cooling surfaces allows for a uniform temperature distribution along the cell normal axis. This reduces hotspots inside the cell.

It also offers advantages if the battery system comprises prismatic cells or pouch cells. These cell shapes offer a large surface area for heat transfer and can be efficiently thermally connected.

It is also advantageous if the heat conductor includes at least one contact section for contact with and/or contacting the second main surface. The contact section ensures direct and low-loss heat transfer from the cell surface to the heat conductor.

It is advantageous if the heat conductor and/or the temperature control element comprises at least one connecting section via which the at least one contact section and the at least one temperature control element can be connected. The connecting section ensures a continuous thermal conductivity chain between the heat conductor and the temperature control element. The temperature control element is preferably an active temperature control element. The heat conductor can only transport heat towards or away from the battery cell. The at least one connecting section allows for the simplest possible connection between the heat conductor and the contact section. This directs the heat flow in a targeted manner from the second main surface, via the end faces, into the temperature control element.

Furthermore, it is advantageous if the at least one connecting section extends along and/or parallel to at least one end face of the battery cell, in particular designed as a lid surface and/or bottom surface, and/or contacts the at least one end face of the battery cell. By contacting the end face, the heat-conducting surface of the battery cell can be increased.

In the present application, the term end face preferably refers to the upper (lid surface) and/or lower (bottom) surface of the prismatic battery cell and/or pouch cell, which is oriented perpendicular to the two large main surfaces. Additionally or alternatively, the side surfaces of the battery cell can be understood as the end face.

It is advantageous if the heat conductor includes at least two connecting sections. This allows the heat to be dissipated along the two connecting sections. Preferably, the at least two connecting sections extend along and/or parallel to two opposing end faces of the battery cell, in particular designed as a lid surface and/or bottom surface. This allows heat to be dissipated both from the bottom and the top of the battery cell between the contact section and the temperature control element. Additionally or alternatively, this improves the redundancy of thermal safety in the event of a failure of a cooling/heating path. Additionally or alternatively, at least two connecting sections are located on the at least two opposing end faces of the battery cell.

It is also advantageous if the heat conductor comprises a highly thermally conductive film and/or a heat pipe and/or a vapor chamber and/or has a thermal conductivity of at least 200 W/m K. Such materials enable rapid and uniform heat distribution and/or dissipation and/or conduction.

It also offers advantages if the heat conductor, in particular in the region of the contact section, is fastened to the second main surface of the battery cell by means of an adhesive. This ensures the most uniform and/or simple contacting and/or fastening possible.

It is also advantageous if the temperature control element has at least one connecting element which preferably extends along and/or parallel to at least one end face of the two adjacent battery cells of a cell unit and/or is preferably designed to thermally connect the respective connecting sections of the two heat conductors to the temperature control element. The connecting element forms a thermally conductive bridge between adjacent battery cells, the temperature control element and/or the at least one heat conductor. This improves heat distribution within the cell unit. Preferably, the connecting element is designed as a connecting plate.

Furthermore, it is advantageous if the temperature control element is arranged between two adjacent battery cells and/or contacts the first main surfaces of the adjacent battery cells facing each other. This ensures even cooling across all adjacent cells. This allows for a homogeneous temperature distribution throughout the entire battery module.

It is advantageous if two adjacent battery cells, the temperature control element arranged between the two adjacent battery cells, and two heat conductors arranged on the second main surfaces facing away from each other of the adjacent battery cells form a cell unit. The cell unit represents a modular structure that allows for efficient scaling of the battery system. This facilitates mass production and/or reduces the effort required for assembly and/or maintenance.

It is also advantageous if the battery system comprises at least one volume compensation element, in particular one that acts as an insulator. Preferably, the volume compensation element is arranged between two cell units. The volume compensation element is preferably designed as a swelling pad. The volume compensation element can protect the battery cells from mechanical deformations, for example during cell growth, swelling process and/or gas leakage. Furthermore, it acts as a thermal barrier between the battery cells and/or cell units. This thermal barrier can, among other things, protect against thermal propagation.

It is also advantageous if the battery system comprises multiple battery cells. Preferably, the temperature control element and the volume compensation element, which has an insulating effect, are arranged alternately between two battery cells. This alternating arrangement ensures an optimal balance between cooling and mechanical cell protection. This allows for a compact and thermally stable cell architecture.

Furthermore, a motor vehicle with a battery system is proposed. The battery system is designed according to the preceding description, wherein the mentioned features may be present individually or in any combination. This battery system enables high energy density while simultaneously improving thermal management.

### BRIEF DESCRIPTION OF THE FIGURES

Further advantages of the invention are described in the following exemplary embodiment. In particular:

FIG. 1 shows a schematic sectional view of a battery system according to an exemplary embodiment.

### DETAILED DESCRIPTION

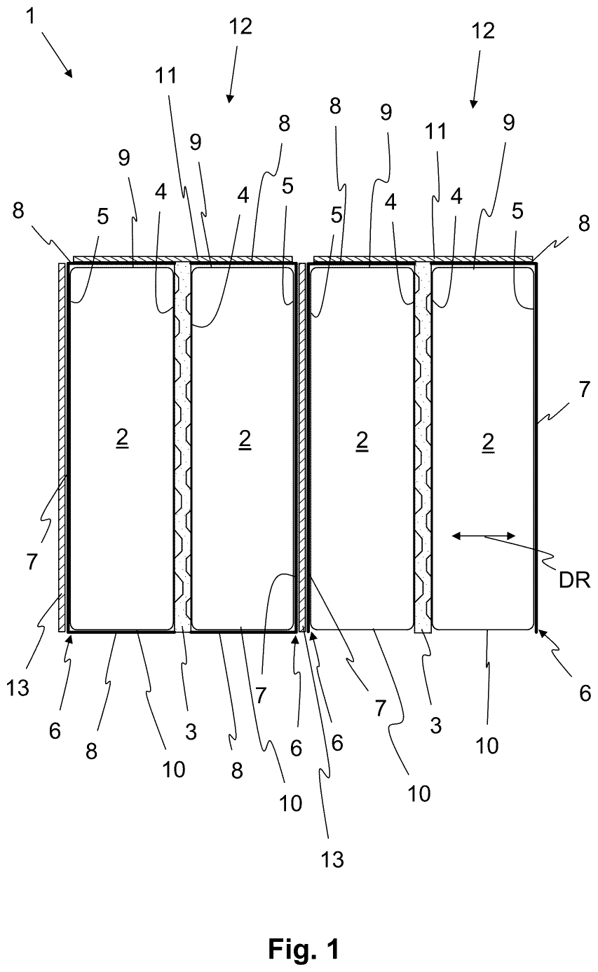

The exemplary embodiment shown in FIG. 1 illustrates a battery system 1 which is intended in particular for use in a motor vehicle. FIG. 1 shows a schematic sectional view of the battery system 1, from which the arrangement and function of essential components can be seen.

In the illustrated exemplary embodiment, the battery system 1 comprises four battery cells 2. However, the battery system 1 according to the present invention can comprise any number of battery cells 2. Each of the depicted battery cells 2 has a first main surface 4 and a second main surface 5 opposite the first main surface 4. The first main surface 4 and the second main surface 5 are spaced apart from each other along a thickness direction DR of the battery cell 2. The thickness direction DR is shown in the present exemplary embodiment only as an example for one of the battery cells 2.

According to the embodiment shown in FIG. 1, a temperature control element 3 is arranged on the first main surface 4 of each battery cell 2. In this case, preferably the first main surfaces 4 of two adjacent battery cells 2 are facing each other. The temperature control element 3 is designed to enable temperature control of the respective battery cell 2, in particular of two adjacent battery cells 2.

As can be seen from the exemplary embodiment shown in FIG. 1, a heat conductor 6 is arranged on the second main surface 5 of the battery cell 2. The heat conductor 6 is thermally connected to the temperature control element 3, ensuring effective heat transfer between the two components. The connection between the heat conductor 6 and the temperature control element 3 contributes to thermal stabilization and/or homogeneous temperature distribution within the battery cell 2.

FIG. 1 also shows that the heat conductor 6 has a contact section 7. The contact section 7 is designed to adhere to or come into contact with the second main surface 5 of the battery cell 2. Additionally or alternatively, it is advantageous if the heat conductor 6 has a connecting section 8. The connecting section 8 serves to connect the contact section 7 and the temperature control element 3.

The connecting sections 8 of the respective heat conductors 6 differ partially from each other in the illustrated exemplary embodiment. Thus, all connecting sections 8 extend along and/or parallel to at least one end face 9, 10 of the battery cell 2. However, for two of the heat conductors 6 shown, only one of the connecting sections 8 is shown, whereas for the other two of the heat conductors 6, two of the connecting sections 8 are shown. In the case of the heat conductors 6, which comprise only the one connecting section 8, this extends, for example, along and/or parallel to an end face 9, 10 designed as a lid surface 9. In the case of the heat conductors 6, which comprise two connecting sections 8, the second connecting section 8 additionally extends along and/or parallel to an end face 9, 10 designed as a bottom surface 10.

These designs are merely examples. Heat conductors 6 with the connecting section 8 exclusively along and/or parallel to the bottom surface 10 are also conceivable. Furthermore, it should be noted that within the battery system 1 the heat conductors 6 are usually, but not necessarily, identically designed. Alternatively or additionally, it offers advantages if the connecting section 8 is directly and/or indirectly and/or immediately adjacent to one of the end faces 9, 10. Heat conduction via the end faces 9, 10 would also be conceivable.

The heat conductor 6 can, for example, be fastened to the second main surface 5 of the battery cell 2 by means of an adhesive. For this purpose, the contact section 7 of the heat conductor 6 and/or the second main surface 5 of the battery cell 2 can comprise the adhesive, and/or the adhesive is applied to the contact section 7 and/or the second main surface 5. This fastening ensures a stable and/or reliable mechanical and/or thermal connection.

In the exemplary embodiment shown in FIG. 1, the temperature control element 3 has a connecting element 11. This connecting element 11 extends, similarly to the connecting section 8 of the heat conductor 6, preferably along and/or parallel to at least one of the end faces 9, 10. Preferably, the connecting element 11 extends along and/or parallel to at least one of the end faces 9, 10 of two adjacent battery cells 2 of a cell unit 12. The connecting element 11 can thereby create the largest possible contact area for the at least one connecting section 8. The connecting element 11 is preferably designed to thermally connect the respective connecting sections 8 of two heat conductors 6 with the temperature control element 3 in order to enable improved heat exchange.

In the exemplary embodiment shown in FIG. 1, the temperature control element 3 is arranged between two adjacent battery cells 2. It is located at the first main surfaces 4 of the two battery cells 2 facing each other. Together with the two heat conductors 6 arranged on the second main surfaces 5 of the battery cells 2, which face away from each other, the two battery cells 2 and the intermediate temperature control element 3 form a cell unit 12. Additionally, the connecting element 11 can be part of the cell unit 12.

In the illustrated exemplary embodiment, two cell units 12 are shown as examples. Each of the cell units 12 comprises two battery cells 2, the one temperature control element 3 and two heat conductors 6. These cell units 12 can be combined and/or scaled in any way. The exemplary embodiment shown in FIG. 1 also shows that the battery system 1 comprises a volume compensation element 13. In the illustrated exemplary embodiment, the volume compensation element 13 is arranged between two adjacent cell units 12. The volume compensation element 13 can be in contact with one of the heat conductors 6 of the adjacent cell units 12. Additionally or alternatively, the at least one volume compensation element 13 can be designed to have an insulating effect.

Finally, FIG. 1 shows that the battery system 1 with the plurality of battery cells 2 is designed such that between each two adjacent battery cells 2 either a temperature control element 3 or an insulating volume compensation element 13 is arranged alternately.

The present invention is not limited to the shown and described exemplary embodiments. Further modifications within the scope of the claims are also possible.

### LIST OF REFERENCE NUMERALS

1 Battery system
2 Battery cell
3 Temperature control element
4 First main surface
5 Second main surface
6 Heat conductor
7 Contact section
8 Connecting section
9 Lid surface
10 Bottom surface
11 Connecting element
12 Cell unit
13 Volume compensation element
DR Thickness direction

1. A battery system for a motor vehicle, comprising: at least one battery cell and with at least one temperature control element for temperature control of the at least one battery cell,
wherein the at least one temperature control element is at least partially in contact with a first main surface of the battery cell, and
at least one heat conductor arranged on a second main surface of the battery cell opposite the first main surface, wherein the at least one heat conductor and the at least one temperature control element are thermally conductively connected to each other.

2. The battery system according to claim 1, wherein the heat conductor comprises at least one contact section for contacting with and/or contacting the second main surface and/or at least one connecting section for connecting the at least one contact section and the at least one temperature control element.

3. The battery system according to claim 1, wherein the at least one connecting section extends along and/or parallel to at least one end face of the battery cell, and designed as a lid surface and/or bottom surface, and/or contacts the at least one end face of the battery cell.

4. The battery system according to claim 1, wherein the heat conductor comprises at least two connecting sections, wherein the at least two connecting sections extend along and/or parallel to two mutually opposing end faces of the battery cell and/or contact the two mutually opposing end faces of the battery cell.

5. The battery system according to claim 1, wherein the heat conductor comprises a highly thermally conductive film and/or a heat pipe and/or a vapor chamber and/or has a thermal conductivity of at least 200 W/m K.

6. The battery system according to claim 1, further comprising two respectively adjacent battery cells, the temperature control element arranged between the two adjacent battery cells and two heat conductors arranged on the second main surfaces of the adjacent battery cells facing away from each other form a cell unit.

7. The battery system according to claim 6, wherein the temperature control element has at least one connecting element which extends along and/or parallel to at least one end face of two adjacent battery cells of a cell unit and/or thermally connects the respective connecting sections of the two heat conductors to the temperature control element.

8. The battery system according to claim 1, further comprising: at least one volume compensation element, wherein the volume compensation element is arranged between two cell units.

9. The battery system according to claim 8, further comprising: a plurality of battery cells, wherein the temperature control element and the volume compensation element are arranged alternately between two battery cells.

10. A motor vehicle comprising a battery system, wherein the battery system is designed according to claim 1.

11. The battery system according to claim 2, wherein the at least one connecting section extends along and/or parallel to at least one end face of the battery cell, and designed as a lid surface and/or bottom surface, and/or contacts the at least one end face of the battery cell.

12. The battery system according to claim 2, wherein the heat conductor comprises at least two connecting sections, wherein the at least two connecting sections extend along and/or parallel to two mutually opposing end faces of the battery cell and/or contact the two mutually opposing end faces of the battery cell.

13. The battery system according to claim 3, wherein the heat conductor comprises at least two connecting sections, wherein the at least two connecting sections extend along and/or parallel to two mutually opposing end faces of the battery cell and/or contact the two mutually opposing end faces of the battery cell.

14. The battery system according to claim 2, wherein the heat conductor comprises a highly thermally conductive film and/or a heat pipe and/or a vapor chamber and/or has a thermal conductivity of at least 200 W/m K.

15. The battery system according to claim 3, wherein the heat conductor comprises a highly thermally conductive film and/or a heat pipe and/or a vapor chamber and/or has a thermal conductivity of at least 200 W/m K.

16. The battery system according to claim 4, wherein the heat conductor comprises a highly thermally conductive film and/or a heat pipe and/or a vapor chamber and/or has a thermal conductivity of at least 200 W/m K.

17. The battery system according to claim 2, further comprising: at least one volume compensation element, wherein the volume compensation element is arranged between two cell units.

18. The battery system according to claim 3, further comprising: at least one volume compensation element, wherein the volume compensation element is arranged between two cell units.

19. The battery system according to claim 4, further comprising: at least one volume compensation element, wherein the volume compensation element is arranged between two cell units.

20. The battery system according to claim 5, further comprising: at least one volume compensation element, wherein the volume compensation element is arranged between two cell units.
